(19) United States
(12) Patent Application Publication
(10) Pub. No.: US 2011/0317254 A1
(43) Pub. Date: Dec. 29, 2011

(54) NONLINEAR OPTICAL DEVICE USING NONCENTROSYMMETRIC CUBIC MATERIALS FOR FREQUENCY CONVERSION

(76) Inventor: Navin Bhailalbhai Patel, Sao Paulo (BR)

(21) Appl. No.: 13/255,407

(22) PCT Filed: Mar. 8, 2010
(86) PCT No.: PCT/BR2010/000071

§ 371 Date: Sep. 8, 2011

(30) Foreign Application Priority Data
Mar. 12, 2009 (BR) PI 0901016-5

(51) Int. Cl. G02F 1/35

(52) U.S. Cl. 359/326

(57) ABSTRACT

This invention is directed to a new class of nonlinear optical device (NLO). For this purpose, in one aspect of this invention, a nonlinear optical device including a first nonlinear optical grating is presented. According to one version of the invention, the first nonlinear optical grating comprises a plurality of adjacent nonlinear optical units arranged in series. Each NLO unit has a single crystal segment and a polycrystalline segment. The single crystal segment is composed of a nonlinear optical crystal material and has its length adapted to provide the nonlinear optical effect. The polycrystalline segments are adapted in length to compensate the phase mismatch among the waves that occur in the single crystal segment.

### BRIEF DESCRIPTION

The present invention relates to the field of nonlinear optics. The invention allows fabrication of efficient devices for light frequency conversion using non-centrosymmetric cubic materials. These materials, e.g. III-V and II-VI compounds have desirable properties for these devices, such as wide transparency range, high nonlinear “d” coefficient, and high degradation resistance.

### FUNDAMENTALS

Light wave frequency conversion using the nonlinear three-wave interaction process can be conversion of: (1) two waves into one (addition or difference of frequencies) or (2) one wave into two (parametric oscillator). The creation of the second harmonic is a special case of the first type of conversion in which two entering waves have the same frequency. The nonlinear interaction needs a nonlinear medium (solid, liquid or gas) to occur. This medium not only should react linearly to light's electromagnetic field but also have a nonlinear component, although small and measured by its “d” nonlinear coefficient. This type of three-wave interaction in a nonlinear medium is also called parametric interaction.

When a light wave crosses a medium, electromagnetic energy causes polarization of atoms that are part of the medium, creating electrical dipoles. The oscillation of these dipoles reradiates the electromagnetic wave, but the interaction leads to light speed decrease by a factor “n” which is called medium refractive index. This interaction usually involves many resonance peaks and between the resonance peaks, the “n” index is generally a monotonically decreasing function of the light wavelength. Thus, different frequency waves travel at different speeds in a medium and this property is referred to as medium dispersion.

The dispersion results in the three waves involved in the parametric interaction getting separated from each other in phases across the medium and ends in efficiency decrease of the nonlinear process. Eventually, when the difference in phases between the entering and resulting waves reach 180°, the energy process direction is inverted. When the differences among the phases reach 360°, the energy conversion direction of the parametric process gets back to the original direction. So, the result is that the intensity of the wave generated in the nonlinear process as a function of the distance crossed in the nonlinear medium oscillates as shown in curve “D” in FIG. 7, and the oscillation period is 2L_{c}, in which L_{c} is the coherence length. Therefore, in order to have an efficient parametric process it is necessary to arrange a scheme to allow the phase matching of the three waves.

Historically, the first scheme invented to obtain that result was to use birefringent crystals, in which the refraction index difference is compensated by the index difference between ordinary and extraordinary waves (orthogonal polarizations) caused by birefringence.

When a perfect wave match is obtained in that way, the intensity of the wave generated in the nonlinear crystal increases quadratically with the distance, as shown in (A) in FIG. 7. An issue with this method is that birefringent crystals are few and very susceptible to damages at high light potencies.

Aware of this situation, the first work, performed in 1962, elucidating the electromagnetic theory of parametric processes, Armstrong, et. Al (J. A. Armstrong, et al. Interactions Between Light Waves In Nonlinear Dielectric, Phys. Rev., 127, 1918-39 (1962)), proposed a method making possible use of non birefringent nonlinear crystals. This method, nowadays widely used in the photonic industry, is called “Quasi Phase Matching”—“QPM”. In this method, crystalline axes of a nonlinear crystal are inverted at regular intervals, with a length corresponding to L_{c}, (FIG. 5). In practice, this inversion is made by the application of a very strong electrical field on ferroelectric crystals like Lithium Niobate.

The periodic inversion of the crystal axis periodically inverts the sign of the nonlinear coupling coefficient “d” (becoming—d). As a result, the crystal polarization is periodically returned to be in the same phase as the input waves. It allows a positive flow of input wave energy to output wave, as well as an intensity increase of the generated wave, as shown in curve (B) of FIG. 7 with the distance traveled. A great limitation of this method is that many crystals popularly used in photonics, such as III-V and II-VI compounds, and that have nonlinear “d” coefficients larger than ferroelectric crystals cannot be used due to not being ferroelectric and, consequently, do not allow crystalline axes' inversion.

There is a patent deposited in the USA in 1974 under U.S. Pat. No. 3,842,289 and title “THIN FILM WAVEGUIDE WITH A PERIODICALLY MODULATED NONLINEAR OPTICAL COEFFICIENT”.

In this patent, it is analytically demonstrated that a periodic modulation of “d”, the average nonlinear coefficient of a wave guide with a period of 2L_{c}, can lead to a parametric interaction among the three waves propagating through the guide. Actually, the “QPM” device of FIG. 5. is a special case of this idea, in which “d” is modulated between +d e −d, and that allows the maximum efficiency for this type of device. Said patent generalizes this idea to any modulation (lower) of “d”. One of the proposals of this patent to modulate “d” is to alternate the sections of a different material (such as air, amorphous material or polycrystalline material) that has a nonlinear coefficient different from the crystalline section material. It then affirms that the amorphous or polycrystalline material can be made of the same material as the single crystal material of the crystalline sections, since the amorphous or polycrystalline material has a different “d” coefficient, implying that it would be zero as air's, different from the single crystal's “d”. This is not true since we know today that “d” in polycrystalline material is the same as “d” in monocrystal, but that it not important as a dispute in terms of originality with this patent request because the proposed physical mechanism is totally different. The proposed physical mechanism of the device of this invention is to diminish the average size of grains in the polycrystalline material up to the point of reducing the nonlinear interaction intensity in these segments to an insignificant amount.

### SUMMARY OF THE INVENTION

This invention is directed to a new class of nonlinear optical devices (NLO). For this purpose, in one aspect of this invention, a nonlinear optical device comprising a first nonlinear optical grating is presented.

According to one version, the first nonlinear optical grating includes a plurality of adjacent nonlinear optical units arranged in series. Each NLO unit has a single crystal segment and a polycrystalline segment as shown in FIG. 6. The single crystal segment is composed of a nonlinear optical crystal and has its length adapted to provide the nonlinear optical effect. The polycrystalline segments are length-adapted to compensate the phase difference created among the waves in the single crystal segment.

In one version, each NLO unit has substantially the same length as nL_{c}, in which n is an even number and L_{c} is the coherence length of the nonlinear optical interaction for which the grating was created. In addition, although different NLO units preferably have almost the same length, there could be different lengths as well. More preferably, the single crystal segment of each NLO unit has substantially the same length as xL_{c} and the polycrystalline segment has substantially the same length as yLc, and the total length of each NLO unit is substantially the same as nL_{c}, in which x and y are odd numbers and n is an even number. In a second alternative, the single crystal segment of each NLO unit, has the same length as xL_{c} and the polycrystalline segments have the same length as yL_{c}, and the total length of each NLO unit is substantially the same as nL_{c}, in which x and y are odd numbers or fractional numbers and n is an even number. Ideally x, y, in the versions mentioned above, are equal to 1 so that the single crystal segment and polycrystalline segment have approximately the same length and n is equal to 2. In addition, the single crystal segment preferably comprises a cubic crystal, and preferably a non-centrisymmetric single crystal. Preferably, the polycrystalline segments comprise the same material as the single crystal segment. It assures that the refractive index is the same in the crystalline segment and in the polycrystalline segment, avoiding multiple reflections of propagating waves at the interfaces between adjoining segments.

In a preferred embodiment of the invention, L_{c} is equal to (Π/|Δk|), in which Δk is the phase mismatch factor, equal to k₃−k₁−k₂, in which k₁, k₂ and k₃ correspond to the wave vectors for each light wave interacting in the nonlinear interaction, and k₁=n₁ω₁/c, k₂=n₂ω₂/c and k₃=n₃ω₃/c, in which ω₁, ω₂, and ω₃ correspond to the frequency of each light wave involved in the nonlinear interaction, ω₃ is the largest frequency involved in the interaction, and n₁, n₂ and n₃ are the indices of refraction of the nonlinear optical material at the frequencies ω₁, ω₂, ω₃, respectively.

Including a polycrystalline segment in each NLO unit, allows to obtain a modified type of quasi phase matching in the first nonlinear optical grating. However, instead of having to periodically invert the crystal axis as illustrated in FIG. 5 for the conventional QPM method, the axis of each crystalline segment is directed in the same direction. As a result, the class of nonlinear optical materials that can be used to reach phase match condition is significantly increased with the optical devices of this invention.

The first nonlinear optical grating can be used for a range of nonlinear optical devices, including for instance frequency doublers, frequency adders, frequency subtractors, amplifiers, parametric oscillators and optical mixers. Although nonlinear optics is preferably utilized to support a nonlinear interaction of second order, the nonlinear optical device can be setup to support nonlinear optical interactions of higher orders, including, for instance, third and fourth order the interactions. In addition, the nonlinear optical device can constitute core of an electromagnetic wave guide, preferably a guide that permits propagation of first order modes.

In another version of the invention, the nonlinear optical device can still include a second nonlinear optical grating. A second grating can be adjacent to the first grating in a side-by-side version or arranged in series with the first grating. In addition, the nonlinear optical grating can include, for instance, a grating selected from a compound group of a uniform grating, a fan-out grating and a chirped grating.

Other aspects, objects, desirable features and advantages of the described invention will be better understood through the detailed description and the following drawings, in which some versions of the invention are illustrated as examples. It is expressly understood that the description and drawings are for illustration effects and are not intended to define the scope limits of the invention.

### DESCRIPTION OF DRAWINGS

FIG. 1A is a schematic view of one version of a nonlinear optical device version, according to this invention that uses the generation of sum frequency;

FIG. 1B is a description of energy levels in the process of generating sum frequency;

FIG. 2A is a schematic view of a second version of the nonlinear optical device, according to this invention that uses second harmonic generation;

FIG. 2B represents the energy levels, in the process of generating the second harmonic;

FIG. 3A is a schematic view of a different version of the nonlinear optical device, according to this invention, that uses the creation of the frequency difference;

FIG. 3B is a description of energy levels in the process of generating frequency difference;

FIG. 4 is a schematic view of a parametric oscillator according to this invention;

FIG. 5 is a schematic view of a previous art of quasi phase matching in crystals;

FIG. 6 is a schematic view of a version of the nonlinear optical device of this invention;

FIG. 7 is a comparative chart, analyzing the spatial variation of the output intensity I₃ of the wave generated in a nonlinear optical interaction in four different conditions of phase matching;

FIG. 8 is a perspective view of a uniform nonlinear optical grating according to this invention;

FIG. 9 is a perspective view of a chirped nonlinear optical grating, according to this invention;

FIG. 10 is a perspective view of a nonlinear fan-out optical grating, according to this invention;

FIG. 11 is a perspective view of a multiple nonlinear optical grating according to this invention.

### DETAILED DESCRIPTION OF THE INVENTION

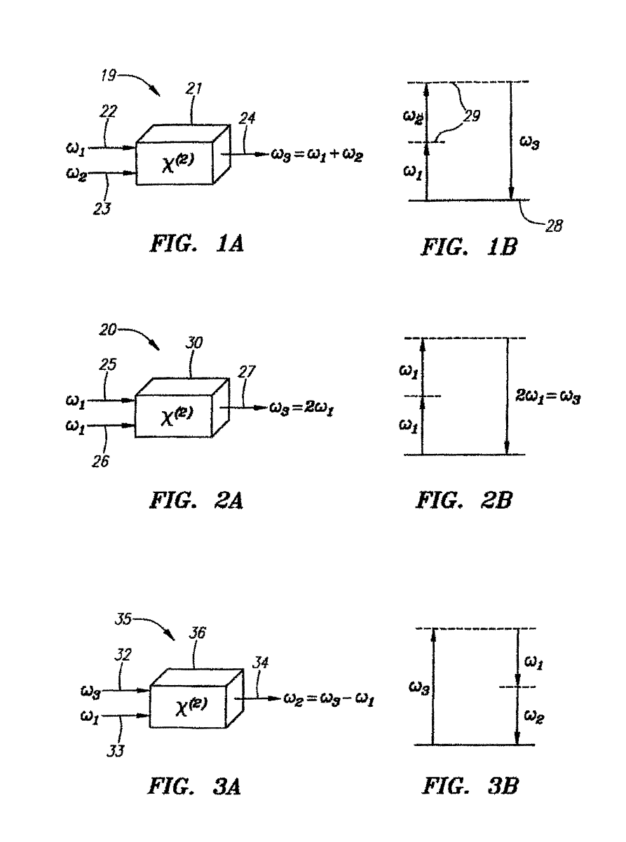

Four nonlinear optical devices, according to this invention, are schematically illustrated in FIGS. 1 to 4.

FIG. 1A is a schematic illustration of a nonlinear optical device (19), according to this invention. The nonlinear optical device (19) is an optical device for the generation of sum frequencies. The generation of sum frequency can be understood as a welding process in which two photons are welded together to produce a single photon with the added energy of both original photons. The nonlinear optical device (19) is comprised of a nonlinear optical medium (21). The nonlinear optical medium (21) consists of a nonlinear optical grating, such as the nonlinear optical grating (60) shown in FIG. 6, which is configured in this version to perform sum frequency generation in the interaction process of three light waves with frequencies ω₁, ω₂ and ω₃. As noted in FIG. 1A, input light waves 22, 23, with frequencies ω₁ and ω₂, respectively, enter in the nonlinear optical medium (21) and interact to produce an output wave (24), with the frequency ω₃=ω₂+ω₁. FIG. 1B is a schematic diagram of photon energy levels describing the energy conservation that occurs in the process of sum frequency generation and shows that two photons at frequencies ω₁ and ω₂ are consumed for each photon of frequency ω₃ produced by the frequency addition process. Therefore, two low frequency input photons ω₁ e ω₂ are destroyed and a higher frequency output photon ω₃ is simultaneously created in a single quantum mechanical process. Line (28) in FIG. 1B represents the fundamental atomic state; and lines (29) represent what is known as virtual states.

FIG. 2A is a schematic view of a second version of the nonlinear optical device (20), according to this invention. The nonlinear device (20) is an optical device that doubles the frequency, employing the creation of the second harmonic. The creation of the second harmonic or doubled frequency is a process most commonly used in mixing frequencies and is a special case of sum frequency generation, to with, the case in which frequencies of two input waves are the same.

The nonlinear optical device (20) consists of a nonlinear optical medium (30). The nonlinear optical medium (30) comprises a nonlinear optical grating (60), shown in FIG. 6, which is configured in this version to perform second harmonic generation of light waves with frequency ω₁. As observed in FIG. 2A, input waves (25), (26) of light in frequency ω₁ enter the nonlinear optical medium (30) and interact to produce an output wave (27), the addition of frequencies ω₃=2ω₁. FIG. 2B represents the schematic diagram of the photons' energy levels describing the energy conservation that occurs in the second harmonic generation and shows that two photons of frequency ω₁ are consumed for each photon with frequency ω₃=2ω₁ produced by a second harmonic generation process.

FIG. 3A is a schematic view of a different nonlinear optical device version (35), according to this invention. The nonlinear device (35) is a frequency subtractor optical device that employs frequency difference creation or parametric amplification. The nonlinear optical device (35) consists of a nonlinear optical medium (36). The nonlinear optical medium (36) comprises a nonlinear optical grating (60), as shown in FIG. 6, which in this invention is configured to perform the light wave difference frequency generation in the interaction of light with three frequencies ω₁, ω₂ e ω₃. As can be seen in FIG. 3A, input waves (32), (33) light frequencies in ω₃ e ω₁., respectively, interact in nonlinear optical medium (36) to produce an output wave in frequency ω₂=ω₃−ω₁. By analyzing diagram 3B of the energy levels of photons involved in the difference frequency generation process, it can be seen that the energy conservation imposes that for each ω₂-frequency photon generated by destroying a ω₃-frequency photon, an additional ω₁-frequency photon is also generated. In other words, the entering wave with the lower frequency, ω₁, is amplified and that is why the frequency difference generation process is also known as parametric amplification.

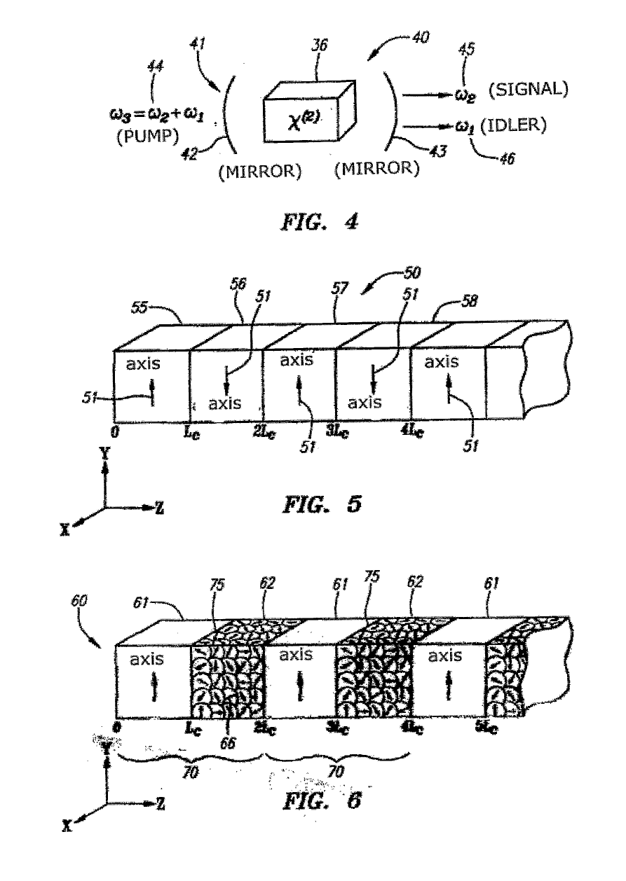

FIG. 4 is a schematic illustration of a nonlinear optical device (40), according to this invention. The nonlinear device (40) is an optical parametric oscillator. The nonlinear optical device (40) includes a nonlinear optical support (36) defining a nonlinear optical grating (60) as shown in FIG. 6, which is configured to perform difference frequency of generation with light waves interacting with three frequencies ω₁, ω₂ and ω₃. Parametric optical oscillators are tunable because any frequency ω₁, less than ω₃ can satisfy the condition of ω₂+ω₁=ω₃. The applied field frequency ω₃ is called pumping frequency (44), the desired output frequency, ω₂, is called signal frequency (45), and the other output frequency, ω₁, is called idle frequency (46).

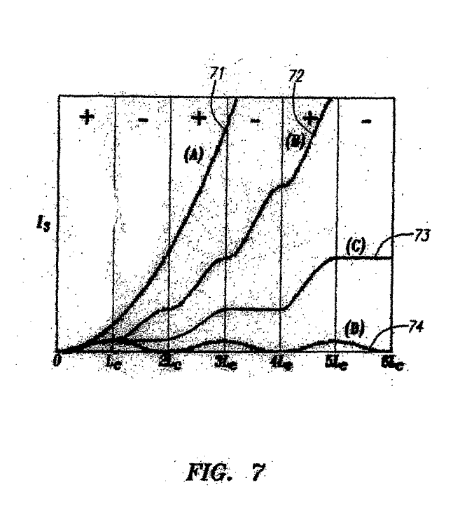

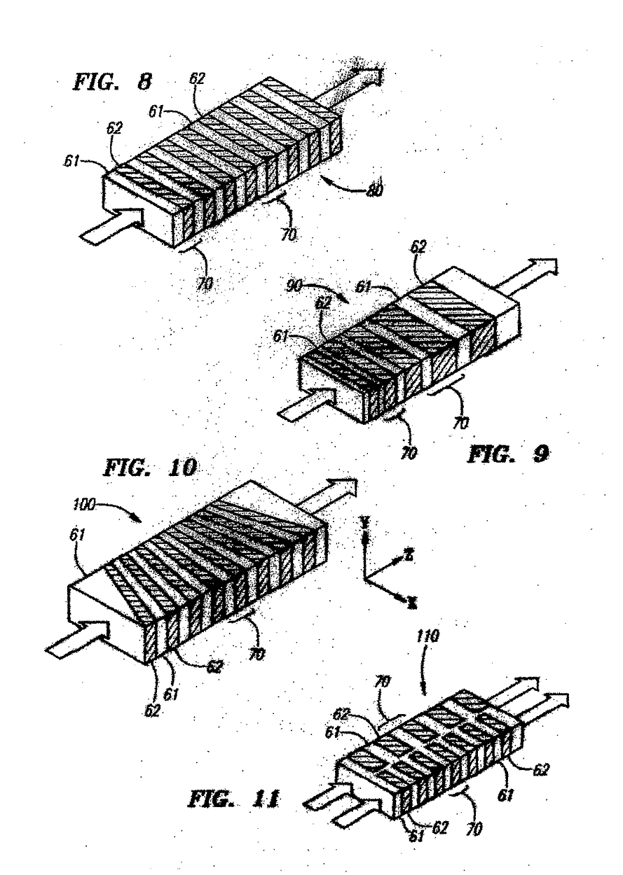

FIG. 5 is a schematic view of a previous art of a periodically polarized nonlinear optical crystal (50), designed for achieving quasi phase matching. The single crystal (50) has been periodically polarized so that the crystalline axis orientation (51), the y axis of the crystal, is inverted at equal internals each of length L_{c}, corresponding to the coherence length, throughout the z axis. Therefore, the first segment (55) of single crystal (50) with L_{c} length has its crystalline axis (51) in the positive direction, the second segment (56) of single crystal (50) with L_{c} length (for a total length 2L_{c}) has its crystalline axis (51) in the negative direction, the third segment (57) of the single crystal (50) with L_{c} length (for a total length 3L_{c}) has its crystalline axis (51) in the positive direction up to the fourth single crystal segment (58) of the crystal (50) with L_{c} length (for a total length 4L_{c}) has its crystalline axis (51) in the negative direction, and so on. A crystalline axis inversion leads to a signal inversion of the nonlinear coefficient of coupling d_{eff}. Thus, the periodic inversion of the nonlinear coefficient at each length L_{c} will compensate the resulting phase mismatch due to dispersion, so that the power will continue to flow from input waves to output waves, in case of the sum frequency generation for instance. As a result, the output wave intensity (I₃) increases as shown in curve (B) in FIG. 7. The detailed technical description of quasi-phase matching can be found in R. Boyd, Nonlinear Optics. Second Edition in pp. 107-111 (2003).

FIG. 6 shows a schematic view of a nonlinear optical grating (60), according to a version of the present invention. The nonlinear optical grating (60) provides a new technique to obtain a modified type of quasi-phase matching in a nonlinear optical medium, such as the mediums (21), (30) and (36) used in the nonlinear optical devices described above.

The nonlinear optical grating (60) is made of a plurality of adjacent nonlinear optical units (NLO) (70) arranged in series. Each NLO unit (70) comprises a single crystal segment (61) and a polycrystalline segment (62). Preferably, the single crystal segment (61) of each NLO unit (70) is made of a non-centrosymmetric cubic crystal and has its crystalline axis in the same y direction throughout, and the polycrystalline segment (62) of each NLO unit (70) is made of grains of the same material.

The length of the single crystal segment (61) of each NLO unit (70) is adapted to provide a desired nonlinear optical effect, such as sum frequency generation, second harmonic generation or frequency difference generation. In addition, each polycrystalline segment (62) of the NLO units (70) has a length adapted to compensate the phase mismatch that occurs in the single crystal segment (61) in its NLO unit. In the version illustrated in FIG. 6, each of the single crystal segments (61) and each of the polycrystalline segments (62) has the length corresponding to the L_{c}, the coherence length, corresponding to the nonlinear optical interaction desired. Therefore, each NLO unit (70) included in the grating (60) of the illustrated version has the same length, equal to 2L_{c}. However, other lengths of single crystal segments (61), polycrystalline segments (62) and NLO units (70) are possible.

Depending on the symmetry of the atomic arrangement in the crystalline lattice (for instance, cubic, triclinic, tetragonal, etc.), it is intuitively clear that the refractive index, n, in crystalline solids can be a function of the light propagation direction in relation to the crystal axes. Cubic crystals, however, are isotropic in the first order in which the refractive index, n, (or the related parameter, x⁽¹⁾, the dielectric susceptibility of first order) is isotropic, independent of the light propagation direction in relation to the crystal axes. At the same time, the material can have a cubic lattice and still be non centrosymmetric (for instance, GaAs, InP, etc, as opposed to Si, Ge, . . . which are centrosymmetric). The non-centrosymmetric cubic crystals have a nonlinear dielectric response to light, and, therefore, have a term, X⁽²⁾, of second order in the dielectric response in the crystal polarization. It is this term that is responsible for the nonlinear interaction of second order. The polycrystalline segment (62) is preferably composed of the same nonlinear optical material as the single crystal segment (61). This is desirable for several reasons. First, the crystalline individual grains (66) in the polycrystalline segment (62) will have their axes randomly oriented, but if these grains are formed from cubic crystals, the refractive index in the polycrystalline segment (62) will be the same as in the single crystal segment (61), being isotropic. So, the input and output waves' passages through a L_{c} length of polycrystalline material will reach the goal of causing a phase change and bring back the power flow condition from the input wave to the output wave, in the next single crystal segment (61). Secondly, using the same material for polycrystalline segments (62) and single crystal segments (61), both having the same refractive index, avoids undesirable reflections at the interfaces (75), between single crystal (61) and polycrystalline segments (62). Using different materials for the single crystal segment (61) and polycrystalline segments (62) would lead to reflections at the interfaces (75) for one or more light frequencies involved in the nonlinear interaction. And while the amount of light reflected at a certain interface (75) can be small, when it is considered that there will be typically hundreds or thousands of these interfaces in a desired grating (60), the cumulative loss of light may become unacceptable. Thirdly, when using the same cubic material for both single crystal (61) and polycrystalline (62) segments, the global construction of the device is simplified because the coherence length L_{c} in both segments will be the same, even if the polycrystalline segments grains (62) are randomly oriented.

The nonlinear optical devices described in this document are based on the realization that polycrystalline segments (62) can be used in order to substitute the crystalline segments with inverted crystal axis in a conventional grating of periodically polarized single crystal of a quasi phase matched device. In the polycrystalline segment (62) of the grating, according to this invention, however, there is no or minimum energy interchange among frequencies interacting in the polycrystalline segment (62), and it acts as a neutral material, or almost neutral material as far as the nonlinear interaction is considered. So, the output wave intensity for the sum generation process, for instance, may increase up to half of the average value as compared to a periodically polarized conventional crystal, with the waves traveling along the z axis of the nonlinear optical grating (60), as shown in the curve (C) in FIG. 7.

For illustrative purposes, the theoretical intensity generated by a nonlinear optical grating (60) adapted to sum frequency generation is now reviewed. Based on the book of R. Boyd. Nonlinear Optics, Second Edition on p. 75, it is known that for sum frequency generation in a nonlinear single crystal

I₃=(512Π⁵d_{eff}²I₁I₂/n₁n₂n₃λ₃²c)L² sin c²(ΔkL/2)

in which I₁, I₂ and I₃ are the light intensities at frequencies ω₁, ω₂ and ω₃ of the input waves (22), (23) and output wave, (24) respectively; n₁, n₂ and n₃ are the refractive indices of the nonlinear optical medium at the wave lengths λ₁, λ₂ and λ₃ corresponding to the frequencies ω₁, ω₂ and ω₃, respectively; d_{eff} is the nonlinear coefficient of coupling and it is related to the nonlinear susceptibility X⁽²⁾; c is the speed of light in vacuum; L is the crystal length and the effect of the phase mismatch is totally included in the Δk factor. The mismatch factor Δk is equal to k₃−k₁−k₂, in which k₁, k₂ and k₃, correspond to the wave vectors for each light wave interacting in a nonlinear manner and k₁=n₁ ω₁/c, k₂=n₂ ω₂/c and k₃=n₃ ω₃/c. Conventionally, ω₃ is always the highest frequency in the optical waves involved in the nonlinear interaction. For the special case Δk=0, the term sin c² (ΔkL/2), that can be written as sin² (Δk/2)/(Δk/2)², become 1. Therefore, output intensity I₃ in the frequency addition increases with L in a quadratic manner. This condition is known as perfect phase matching and intensity I₃ increases, as shown in curve (A) in FIG. 7. Since all crystals suffer dispersion, the refractive indices of the frequencies in interaction are not the same (n₁≠n₂≠n₃), therefore, Δk≠zero. For Δk≠0, sin c² (Δk L/2), is an oscillating function with L as can be seen in the curve (D) in FIG. 7. Length L_{c}=Π/Δk is called coherence length.

Referring to the polycrystalline segments (62), the individual crystal grains in the polycrystalline material are randomly oriented and there is a random variation of the crystal axis when the light moves from one grain to the next. As result, the phase relation among the interacting light waves begins at zero at each boundary of the new grain, although not necessarily in coherence to that in the previous grain or the previous single crystal segment. This leads to the fact that the nonlinear interactions occurring in different polycrystalline grains (62) will be independent of each other. In other words, the nonlinear interactions that occur in the different polycrystalline grains and segments (62) are not coherent.

As shown below, when the average grain size in the polycrystalline segments (62) is g, then the intensity loss in I₁ and I₂ to generate I₃ will be proportional to g/L_{c}. EQU. (1) can be rewritten as I₃=A L² sin c² (Δk L/2). In which A=(512Π⁵ d_{eff}² I₁I₂)/(n₁n₂n₃λ₃²c). Thus, applying the equation to a grain of length g,

I₃^{g}=Ag² sin c²(Δkg/2)=Ag2 sin²((Δkg/2)/(Δkg/2)²

For very small g, in which g/L_{c}≦10⁻², sin² (Δk g/2)≈(Δk g/2)² therefore, I₃^{g}=Ag².

In a polycrystalline segment with L_{c} length, the average number of grains with g length is L_{c}/g. Since each grain will act independently (not coherently), the total intensity I₃^{Poly} generated in these polycrystalline segments with Lc length will be

I₃^{Poly}=I₃^{g}L_{c}/g=Ag²L_{c}/g=AL_{c}g (Eq. 2)

This amount can now be compared to the intensity generated by single crystal with L_{c} length. The intensity I₃^{SC} generated in a single crystal with length Lc=Π/Δk is:

I₃^{SC}=AL_{c}² sin c²(ΔkL_{c}/2)=AL_{c}² sin c²(ΔkL_{c}/2)=AL_{c}² sin²(Π/2)/(Π/2)²=(4/Π²)AL_{c}². (Eq. 3)

According to EQ. 2 and EQ. 3, the ratio I₃^{poly}/I₃^{SC} can be obtained as follows:

I₃^{poly}/I₃^{SC}=AL_{c}g/((4/Π²)AL_{c}²)=(Π²/4)(g/L_{c})

This ratio is proportional to g/L_{c} and, therefore, can be made insignificantly small by choosing a g much smaller than L_{c}. There is an excellent experimental proof in an early paper “A Powder technique for the evaluation of nonlinear optical material” by S K T. T. Kurtz and Perry, pp. 3798-3813, Journal of Applied Physics, vol. 39, no. 8 (July, 1968). The authors studied the second harmonic generation in compacted crystalline powder materials, which imitate a polycrystalline material, and observed that intensity of the generated second harmonic was proportional to g/L_{c} for g<L_{c}. Another experimental proof that when g/L_{c} tends to zero, the nonlinear interaction efficiency in a polycrystalline material tends to zero can be found in M. Buadrier—Raybaout, et al., “Random Quasi-phase-matching in bulk polycrystalline Isotropic Nonlinear Material”, Nature, vol. 432, 374-76 (Nov. 18, 2004).

Thus, with g/L_{c}≦10⁻², on average, the nonlinear interaction among the three waves in the polycrystalline segments should be negligible, in comparison to the interaction that occurred in the single crystal segment. Since the refractive index of the polycrystalline segments is equal to the single crystal, with L_{c} length as well, the polycrystalline segment should provide the phase change among the waves needed to bring them back in phase so that the energy can flow again from I₁ and I₂ to I₃ in the next single crystal segment.

As a result of intensity increase of I₃ for the output wave (27) with successive passages through the periodic chain of NLO units (70) which form the grating (60) should be similar to curve (C) in FIG. 7. It can be noted that between 0 and L_{c}, the line overlaps line (B) of the conventional devices of quasi-phase matching. Between L_{c} and 2L_{c}, the curve (C) is flat or almost flat, because in the polycrystalline segment (62) there is negligible nonlinear interaction up to the next single crystal segment (61), which is positioned between 2L_{c} and 3L_{c}, in which the energy is again transferred to the output wave (27) and constructively add with the distance propagation. This cycle is repeated with the propagation through the grating (60). As can be seen in FIG. 7, the grating (60) of L length, according to this invention will produce the same output intensity I₃, as a conventional grating of quasi-phase matched single crystal (50), of length L/2.

1. A nonlinear optical device comprising a first grating with a plurality of adjacent nonlinear optical (NLO) units arranged in series, wherein each of the plurality of NLO units is made of a single crystal segment and polycrystalline segment, the single crystal segment is made of nonlinear and length-adapted material in order to provide a nonlinear effect, and the polycrystalline segment is length-adapted to compensate the phase mismatch.

2. The nonlinear optical device according to claim 1, wherein each of the plurality of NLO units has a length substantially equal to nL_{c}, in which n is an even number.

3. The nonlinear optical device according to claim 2, wherein each of the plurality of NLO units has approximately the same length.

4. The nonlinear optical device according to claim 2, wherein at least two of the plurality of NLO units have different lengths.

5. The nonlinear optical device according to claim 1, wherein the single crystal segment has substantially the same length as xL_{c}, and the polycrystalline segment has substantially the same length as yL_{c}, and the total length of each of the plurality of NLO units is substantially the same as nL_{c}, in which x and y are odd numbers and n is an even number.

6. The nonlinear optical device according to claim 5, wherein each of the plurality of NLO units has substantially the same length.

7. The nonlinear optical device according to claim 5, wherein at least two of the plurality of NLO units have different lengths.

8. The nonlinear optical device according to claim 5, wherein x and y are equal to 1 and n is equal to 2.

9. The nonlinear optical device according to claim 5, wherein the single crystal segment and the polycrystalline segment have approximately the same length.

10. The nonlinear optical device according to claim 5, wherein L_{c} is equal to (Π/|Δk|), in which Δk is a phase mismatch factor equal to k₃−k₁−k₂, in which k₁=n₁ω₁/c, k₂=n₂ω₂/c and k₃=n₃ω₃/c in which ω₁, ω₂, and ω₃ correspond to the frequency of each light wave involved in a nonlinear interaction, ω₃ is the largest frequency among the frequencies involved in the interaction, and n₁, n₂, n₃ are the refractive indices of the optical material at frequencies ω₁, ω₂, and ω₃, respectively.

11. The nonlinear optical device according to claim 1, wherein the single crystal segment is as long as the xL_{c}, the polycrystalline segment is as long as the yL_{c}, and the total length of each of the plurality of NLO units is substantially equal to nL_{c}, in which x and y are odd numbers or fractioned numbers and n is an even number.

12. The nonlinear optical device according to claim 1, wherein the single crystal segment is a cubic crystal.

13. The nonlinear optical device according to claim 12, wherein the single crystal is not centrosymmetric.

14. The nonlinear optical device according to claim 12, wherein the polycrystalline segment is formed by the same nonlinear optical material as the single crystal segment.

15. The nonlinear optical device according to claim 1, wherein the first grating is adapted to define a core of an electromagnetic wave guide.

16. The nonlinear optical device according to claim 1, further comprising a second nonlinear optical grating.

17. The nonlinear optical device according to claim 16, wherein the second nonlinear optical grating is adjacent to the first grating placed side by side.

18. The nonlinear optical device according to claim 16, wherein the second grating is arranged in series with the first grating.

19. The nonlinear optical device according to claim 1, wherein the first grating is selected from the group composed of a homogenous grating, a fan-out grating, and a chirped grating.

20. The nonlinear optical device according to claim 1, wherein the single crystal segment includes a non-centrosymmetric cubic crystal of nonlinear optical material with a length adapted in order to provide a nonlinear effect, and the polycrystalline segments is made of the same nonlinear optical material the single crystal segment, and with a length that compensates the phase mismatch of waves that occur in the single crystal segment.

21. The nonlinear optical device according to claim 20, wherein each of the plurality of NLO units has substantially the same length as nL_{c} where n is an even number.

22. The nonlinear optical device according to claim 21, wherein each of the plurality of NLO units has substantially the same length.

23. The nonlinear optical device according to claim 21, wherein at least two of the plurality of NLO units have different lengths.

24. The nonlinear optical device according to claim 20, wherein the single crystal segment has substantially the same length as xL_{c}, the polycrystalline segment has substantially the same length as yL_{c}, and the total length of each of the plurality of NLO units is substantially the same as nL_{c}, in which x and y are odd numbers and n is an even number.

25. The nonlinear optical device according to claim 24, wherein each of the plurality of NLO units has substantially the same length.

26. The nonlinear optical device according to claim 24, wherein at least two of the plurality of NLO units have different lengths.

27. The nonlinear optical device according to claim 24, wherein x and y are equal to 1 and n is equal to 2.

28. The nonlinear optical device according to claim 24, wherein the single crystal segment and the polycrystalline segment have approximately the same length.

29. The nonlinear optical device according to claim 24, wherein L_{c} is equal to (Π/|Δk|), in which Δk is a gap factor equals to k₃−k₁−k₂, in which k₁=n₁ω₁/c, k₂=n₂ω₂/c e k₃=n₃ω₃/c in which ω₁, ω₂, e ω₃ correspond to the frequency of each light wave involved in the non linear interaction, ω₃ is the largest frequency among the frequencies involved in the interaction, and n₁, n₂, n₃ are equal to the refractive indices of the nonlinear optical material at the frequencies ω₁, ω₂, and ω₃, respectively.

30. The nonlinear optical device according to claim 20, wherein the single crystal segment has the same length as xL_{c}, the polycrystalline segment has the same length as yL_{c}, and the total length of each of the plurality of NLO units is substantially the same as nL_{c}, in which x and y are odd numbers or fractionated numbers and n is an even number.

31. The nonlinear optical device according to claim 20, wherein the first grating is adapted to define the core of an electromagnetic waveguide.

32. The nonlinear optical device according to claim 20, further comprising a second nonlinear optical grating.

33. The nonlinear optical device according to claim 32, wherein the second nonlinear optical grating is adjacent to the first grating side by side.

34. The nonlinear optical device according to claim 32, wherein the second grating is arranged in series with the first grating.

35. The nonlinear optical device according to claim 20, wherein the first grating is selected from the group composed of a homogenous grating, a fan-out grating, and a chirped grating.
